(19) United States
(12) Patent Application Publication
(10) Pub. No.: US 2010/0159722 A1
(43) Pub. Date: Jun. 24, 2010

(54) SAFETY SOCKET

(76) Inventor: Gui CHEN, Yueqing (CN)

Correspondence Address: Dr. BANGER SHIA;Patent Office of Bang Shia, 102 Lindencrest Ct, Sugar Land, TX, 77479-5201, US

(21) Appl. No.: 12/344,027

(22) Filed: Dec. 24, 2008

(51) Int. Cl. H01R 13/44

(52) U.S. Cl. 439/137

(57) ABSTRACT

The present invention pertains to a safety socket including a housing providing a top cover shell, a plurality of metal electrodes therein adapted for prongs of a plug as well as sets of jacks on the top cover shell relative to the electrode. Wherein, on the reverse side of the top cover shell, protected panels and resumption assemblies are pivoted thereon. The protected panels further have apertures arranged adapted for the jacks, and the resumption assemblies are positioned at an orientation against ramps to render the jacks closed while there is a juxtaposition between the ramps on the protected panels and the jacks. By the blocked jacks under the cooperation of the protected panels and the resumption assemblies, children would not desire to poke the jacks with articles, so as to efficiently prevent them from touching electricity-friendly elements and from the accident of electric shock.

### BACKGROUND OF THE INVENTION

1. Field of the Invention

The present invention relates to an electric socket, in particular to a safety socket that could prevent children from getting electric shock while incautiously contacting the electric parts within the socket.

2. Description of the Related Art

Generally, the application on more conventional electric sockets becomes a trend since there are more generations of the electric equipments. Herein, the conventional socket is essentially comprised of a housing that includes a top cover shell, a plurality of metal electrodes coinciding with prongs of the plug, and sets of jacks defined on the cover shell relative to the electrodes. Commonly, because such jacks are usually open, children would randomly poke the jacks with any holding articles or their hands to satisfy their curiosities. However, such behaviors may easily incur the occurrences of directly injuring the hands or indirectly shocking with electricity through the articles which are electricity-friendly.

Besides, another conventional socket revealing a GFCI (ground-fault circuit interrupter) generally includes a housing comprised of a body cover shell, a top cover shell with jacks. Particularly, the housing receives a testing circuit of leakage signal, an electromagnetic trip assembly controlled by the testing circuit, a contacting unit, a grounding unit, a power input connector, and a loading connector. Hereby, the GFCI could power the loadings not only through the jacks but also through its loading connectors. Wherein, both the power input connector and the loading connector have their respective wiring plates of conduction coincidently inserted into two inward sides of the body cover shell in which apertures has defined to expose the wiring plates. Therefore, the GFCI socket not only has the same risk as that of the previous typical socket but more increases the electric shock when carelessly touching those exposed wiring plates.

### SUMMARY OF THE INVENTION

To remedy the set forth deficiencies of the conventional sockets, the object of the present invention is to provide a safety socket that can prevent children from getting electric shock by avoiding their incautious poking or touching the electric parts within the socket.

The safety socket in accordance with the present invention mainly provides with a housing including a top cover shell, a plurality of metal electrodes inside the shell adapted for prongs of plugs, and sets of jacks defined on the cover shell relative to the electrodes. It is characterized in that a plurality of protected panels and resumption assemblies are pivoted to the reverse side of the top cover shell and provides with apertures relatively communicate with the jacks. Moreover, a ramp is provided by same side of the apertures relative the same jack set. The protected panel could further slide between a first position at which the apertures are abreast of the slots of the T-shaped jack and a second position where the apertures are across the slots. In addition, the resumption assembly includes a resuming spring set against the orientation of the ramps to render the jack closed while there is an alignment between the ramp and the jack.

In one embodiment, a housing comprises of a body cover shell and a top cover shell with sets of jacks. Wherein, the housing receives a testing circuit of leakage signal, an electromagnetic trip assembly controlled by the testing circuit, a contacting unit, a grounding unit, a power input connector, and a loading connector all received in the housing. Herein, both the power input connector and the loading connector have their respective wiring plates of conduction relatively inserted into two inward sides of the body cover shell as well as exposed out of a window provided therefrom. Especially, the window has a groove for being embedded by a secure shutter.

Further supplemental configuration of the present invention provides with at least one set of the jacks in a T-shaped arrangement that contains the structure of a horizontal and a vertical slots. Moreover, the respective horizontal and vertical panels with respective resumption assemblies are assembled to the reverse side of the top cover shell and are provided with their respective apertures disposed relative to the horizontal and vertical slots of the T-shaped jack. These apertures with respect to the same jack set define ramps at the same relevant side thereof, whereby the horizontal and vertical panels could further slide between a first position where the apertures communicates abreast of the slots of the T-shaped jack and a second position at which the apertures intersects across with the slots thereof. The resumption assemblies are set at an orientation against the ramps, so that the ramps on the horizontal panel could align with the horizontal slot of the T-shaped jack, and likewise the ramps on the vertical panel collocate with the vertical slot.

Therefore, the present safety socket takes advantage of the protected panels and the resumption assemblies pivoted on the reverse side of the top cover shell to render the jacks closed. Thus, children would not desire to poke the jacks and touch the interior electrodes, and the accident of getting electric shock can be avoided. While plugging, users merely insert prongs of a plug to press the ramps and thence compress the resumption assembly to propel the protected panels sliding apart and to juxtapose the apertures of the protected panels fitly with the slots of the jacks, so as to provide the plug with electricity. Therefore, the present invention could attain the higher capability of security.

The advantages of the present invention over the known prior arts will become more apparent to those of ordinary skilled in the art by reading the following descriptions with relating drawings.

### BRIEF DESCRIPTION OF THE DRAWINGS

FIG. 1 is a perspective and exploded view showing a GFCI in the safety socket-style of one preferred embodiment of the present invention;

FIG. 2 is a schematic view showing the reverse side of the top cover shell of the safety socket GFCI;

FIG. 3 is a cross-sectional view showing the unplugging of the safety socket of the present invention;

FIG. 4 is a cross-sectional view showing of the safety socket of the present invention plugged by a plug;

FIG. 5 is a perspective and exploded view showing the appearance of a socket GFCI with T-shaped jacks of the present invention;

FIG. 6 is a perspective view showing the reverse side of the top cover shell of the socket GFCI with T-shaped jacks;

FIG. 7 is a cross-sectional view showing the protected panel with resumption assembly of FIG. 6;

FIG. 8 is a cross-sectional view showing the unplugging of the socket GFCI with T-shaped jacks;

FIG. 9 is another cross-sectional view showing the unplugging of the socket GFCI with T-shaped jacks;

FIG. 10 is a cross-sectional view showing of FIG. 8 inserted by a first plug design;

FIG. 11 is a cross-sectional view showing of FIG. 9 inserted by a first plug design;

FIG. 12 is a cross-sectional view showing of the socket GFCI with T-shaped jacks before plugging a second plug design;

FIG. 13 is a cross-sectional view showing of the socket GFCI with T-shaped jacks inserted by a second plug design;

FIG. 14 is a top perspective view showing the appearance of a safety socket of the present invention;

FIG. 15 is an end exploded view showing of 14;

FIG. 16 is a top exploded view showing the interior of 14;

FIG. 17 is a perspective view showing the appearance of the safety socket with T-shaped jacks; and

FIG. 18 is a detailed perspective view showing another preferred embodiment of the present invention.

### DETAILED DESCRIPTION OF THE PREFERRED EMBODIMENTS

Before describing in greater detail, it should note that the like elements are denoted by the similar reference numerals throughout the disclosure.

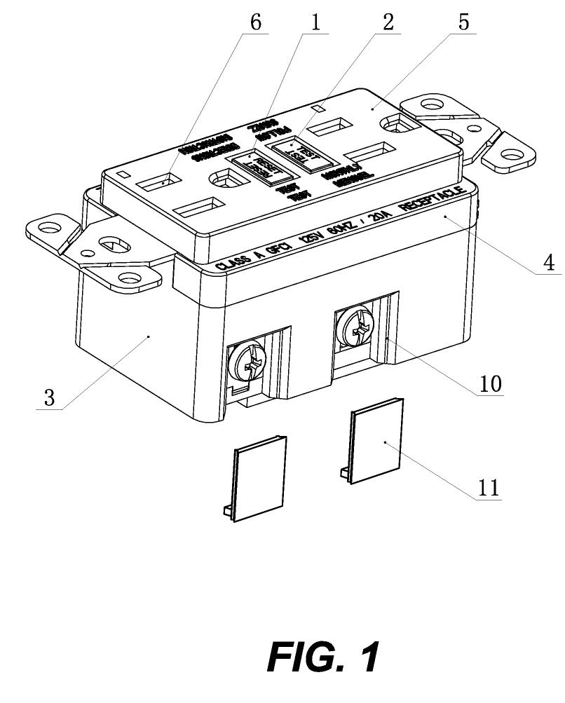

Referring to FIG. 1, a GFCI socket essentially includes a housing, a testing circuit of leakage signal, an electromagnetic trip assembly controlled by the testing circuit, a replacing mean 1, a testing mean 2, a grounding unit, a power input connector, and a loading connector. Wherein, the profile of housing shapes a rectangle; the housing is comprised of a body cover shell 3, a frame 4, and a top cover shell 5 on which two sets of jacks 6, the replacing mean 1 and a testing mean 2 are located. Within the body cover shell 3, a printed circuit board is mounted about the lower portion of the frame 4 for accepting the assemblages of the testing circuit of leakage signal and the electromagnetic trip assembly thereon. Further, both the power input connector and the loading connector have their respective wiring plates of conduction inserted into two inward sides of the body cover shell 3 as well as exposed out of a window where the plates are disposed relative to the inward sides. The window further has a groove 10 for fitly receiving a secure shutter 11.

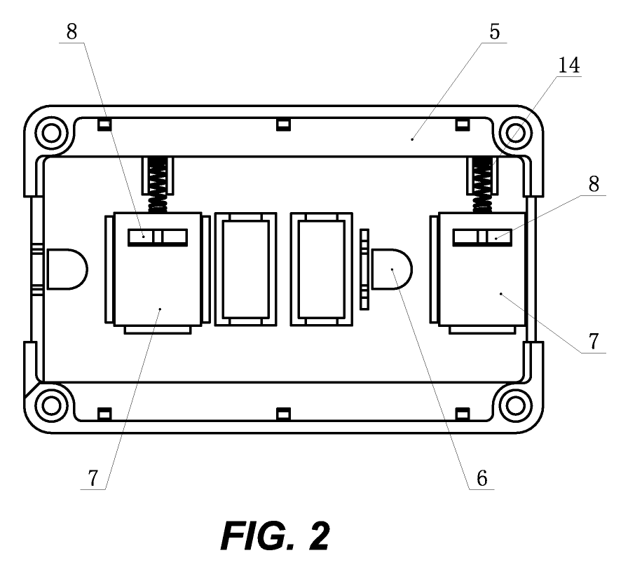

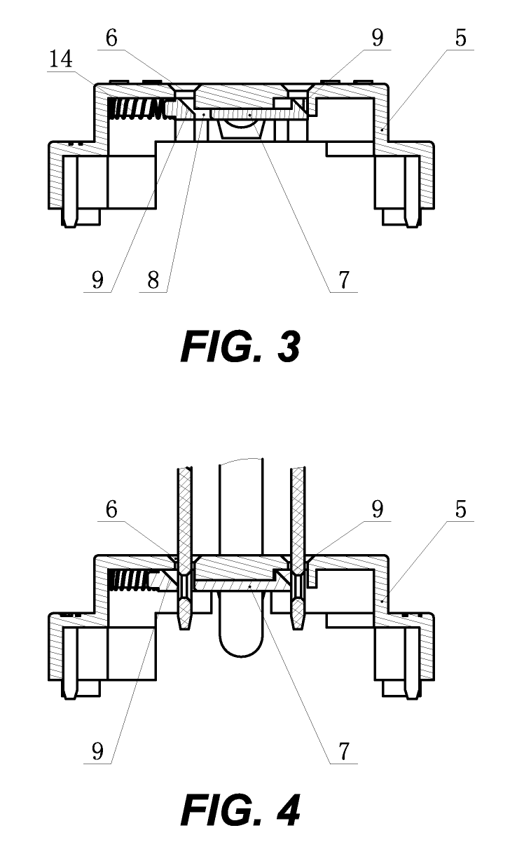

Referring to FIG. 2 to 4, a plurality of protected panels 7 and resumption assemblies are pivoted to the reverse side of the top cover shell 5 and disposed relative to the jacks 6. Each protected panel 7 could further slide between a first position where the apertures 8 communicates abreast of the jack 6 set and a second position where the apertures 8 positions across with the jack 6. Herein, the dimension of the protected panel 7 should at least cover the same jack 6 set. Further, a plurality of apertures 8 are provided on the protected panel 7 to coincidently communicate with the jack 6. Essentially, the prongs of a plug are flat, so that the jack 6 is correspondingly designed into two parallel slots as usual. Since the jack 6 is formed in a substantial slot type, each set of the jack thence could be covered merely by one rectangular protected panel 7. The protected panel 7 has a ramp 9 defined at one side thereof, and the width of the ramp 9 is same to those of the aperture 8 and the protected panel 7. Further, a nick is defined on protected panels 7 parallel to the ramp 9 and has the outline goes with the width of the ramp 9 as well as the slots of the same set jack 6. At the same side of the ramp 9, each nick also provides with a ramp 9, so as to simplify manufacture. As it should be, the ramps 9 are not limited to be defined at one side of the protected panel 7. The ramps 9 could be merely defined at same side of the apertures 8 coinciding with respect to the numerals, collocations, and shapes of the same jack 6 set. Furthermore, the resumption assembly includes a resuming spring 14 reversely set against the orientation of the ramp 9 so as to render the jack 6 closed by aligning the ramp 9 on the protected panel 7 with the slots of the jack 6 while unplugging.

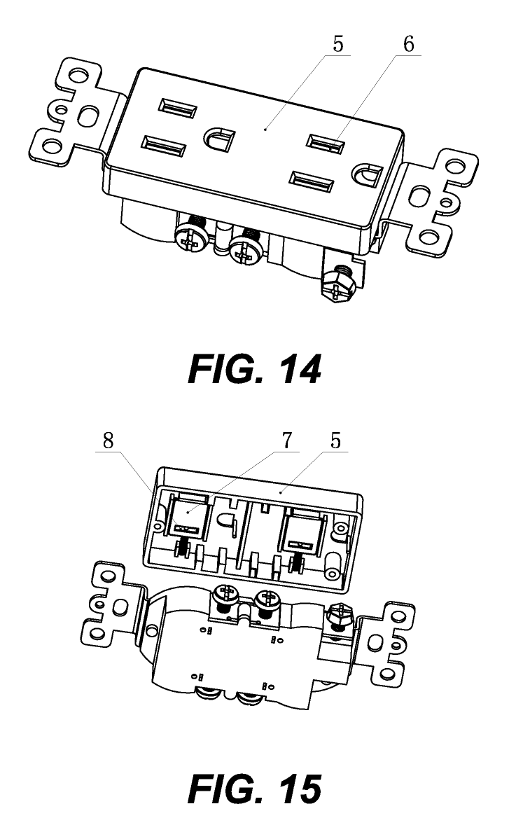

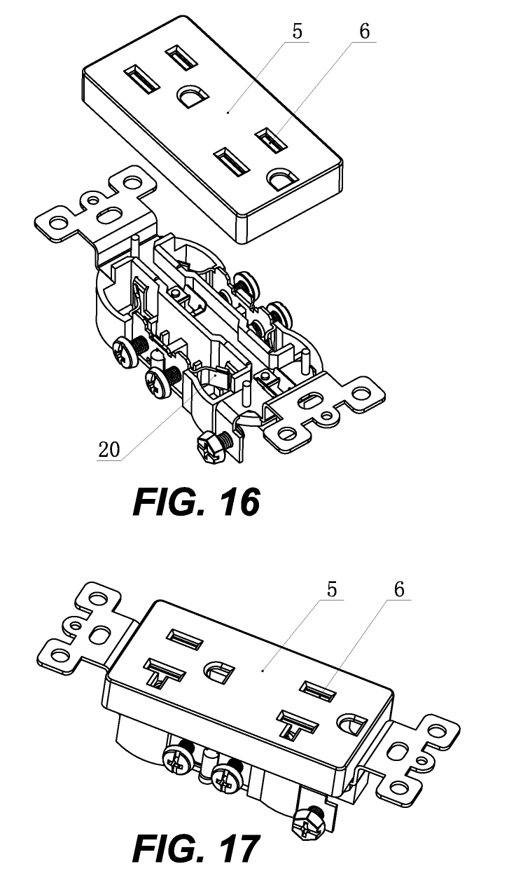

Referring to FIGS. 14, 15, and 16 show a safety socket without the GFCI structure of the present invention. Such typical safety socket has the arrangement of the jacks 6 at which the top cover shell 5 of the housing are disposed relative to the electrodes similar to the aforementioned socket GFCI, except that this socket has merely electrodes 20 inside the interior thereof for adapting with prongs of a plug. The safety socket, with the same concatenation between the protected panel 7 and the resumption assembly, herein still comprises a plurality of protected panels 7 with resumption assemblies pivoted to the reverse side of the top cover shell 5 and provided with apertures 8 relatively adapting with sets of jacks 6. Further, the same set jack 6 with its slots could be covered merely by one rectangular protected panel 7. Moreover, the protected panel 7 has a ramp 9 provided by one side thereof (not shown) and further includes a nick parallel with the ramp 9. Whereby, the width of the nick is same as those of the ramp 9 and the jacks 6 of the top cover shell 5. In addition, about the same side of the ramp 9, each nick also provides with the performance of a ramp 9.

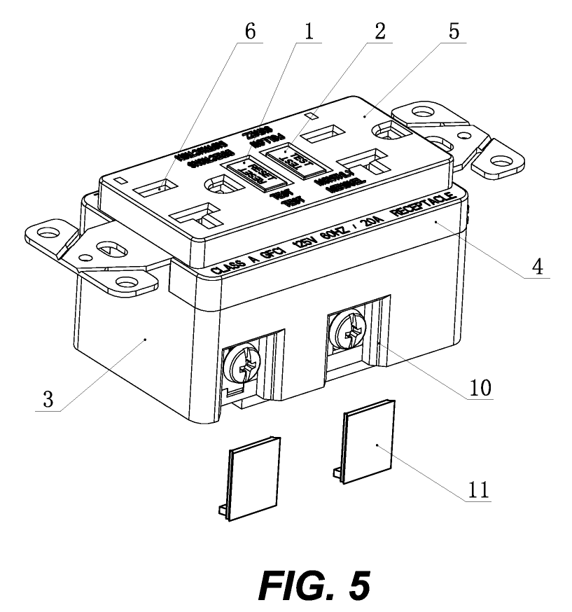

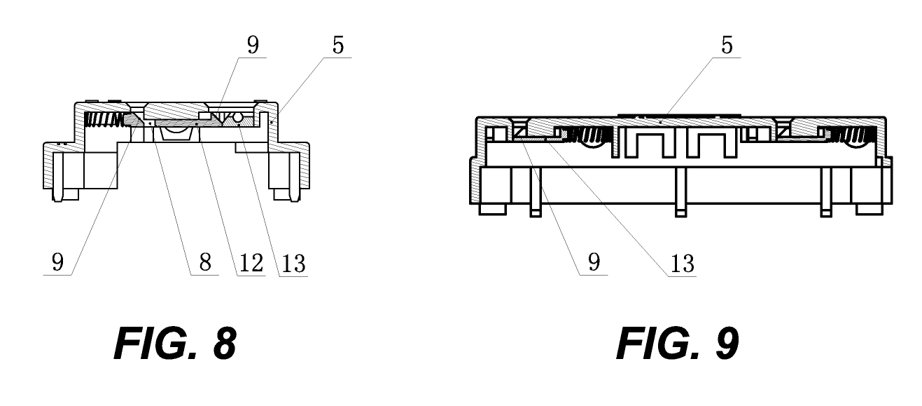

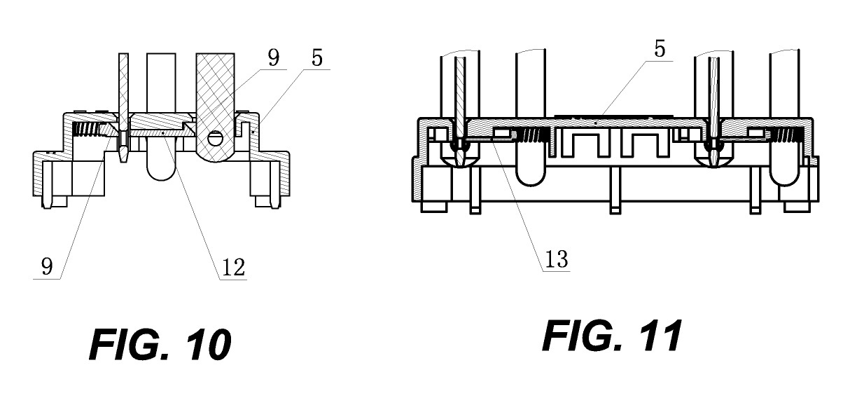

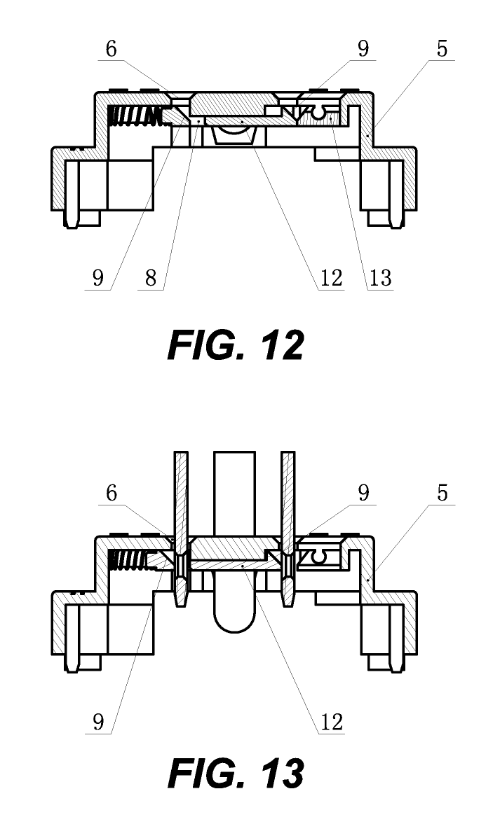

In order to suit applications in different countries or systems, some sockets may arrange their sets of jacks 6 into a T-shaped performance. Referring to FIGS. 5 to 13 and 17 shows each set of the jacks 6 constructed by respective horizontal and vertical slots. To coincide with such slots, the protected panel 7 has discrete horizontal and vertical panels 12 and 13 with resumption assemblies pivoted on the reverse side of the top cover shell 5. Furthermore, the horizontal and vertical panels 12 and 13 have their respective apertures 8 relating to the horizontal and vertical slots of the T-shaped jack. The horizontal and vertical panels 12 and 13 could further slide between a first position where the apertures communicates abreast of the slots of the T-shaped jack and a second position at which the apertures intersects across with the slots thereof. A ramp 9 is defined by same side of the apertures 8 relative to the same jack 6 set, and the resumption assemblies are set at the place against the ramp 9, so that the ramp 9 on the horizontal panel 12 aligns with the horizontal slot of the T-shaped jack and likewise the ramp 9 on the vertical panel 13 coincidently collocates with the vertical slot while unplugging.

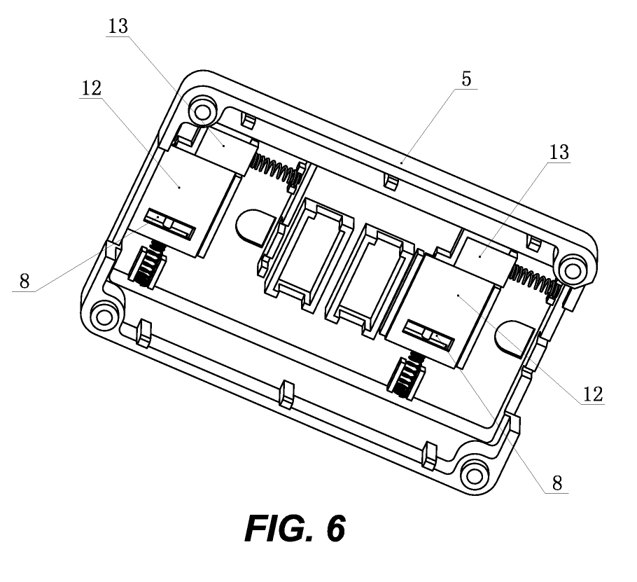

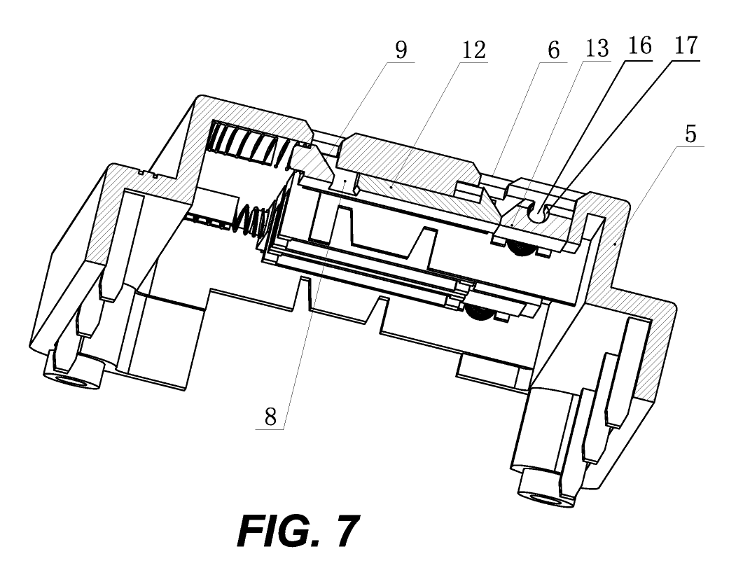

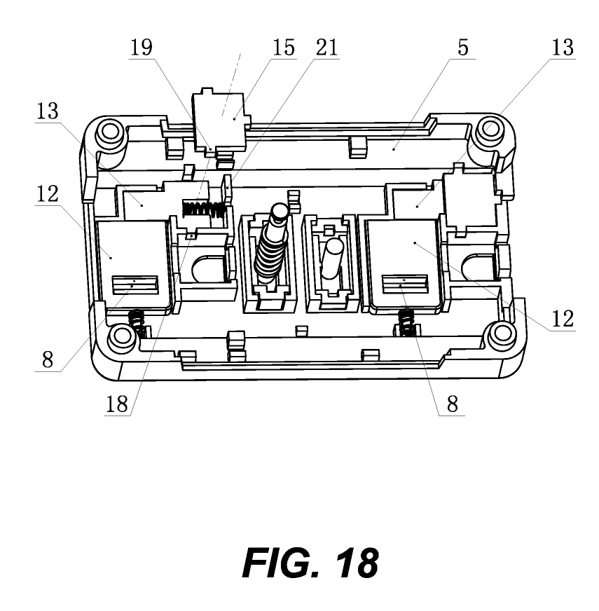

Additionally, as shown in FIGS. 6 and 7, the protected panel 7 can be pivoted to the rear of the top cover shell 5 by properly embedding a convex member 16 protruded from cover shell 5 into a guiding concave 17 defined on the panel 7. Alternatively, a conducting board 21 and a locating plate 15 raised about the jacks 6 also facilitates in assembling the protected panel 7 to the reverse side of the top cover shell 5 as shown in FIG. 18. Whereby, the protected panel 7 would slide by the guidance of the conducting board 21. Herein, the height of the conducting board 21 is lengthier than the thickness of the protected panel 7. A notch 18 is provided on the conducting board 21, and a knot 19 is defined on the side of the locating plate 15 to fit with the notch 18 for pivoting the conducting board 21 on the reverse side of the top cover shell 5.

As a result, while the socket is unplugged, the protected panels 7 consisted of the horizontal and vertical panels render the slots of the jacks 6 closed by the abreast collocation of the ramps 9 and the jacks 6 under the resilience of the resumption assemblies. Therefore, the occurrence of getting electric shock can be avoided while children intend to poke the jacks with their curiosities. While plugging, users merely inserts prongs of a plug to press the ramps, which would further compresses the resumption assembly (resuming spring) to make the protected panel slide apart. Accordingly, such action effects to coincidently juxtapose the apertures of the protected panels with the slots of the jacks for providing the plug with electricity. Therefore, the present invention could attain the higher capability of security.

While we have shown and described the embodiment in accordance with the present invention, it should be clear to those skilled in the art that further embodiments may be made without departing from the scope of the present invention.

I claim:

1. A safety socket comprising a housing including a top cover shell, a plurality of metal electrodes within said top cover shell adapted for prongs of a plug, and sets of jacks defined on said top cover shell relative to said electrodes;
characterized in that a plurality of protected panels and resumption assemblies being pivoted on the reverse side of said top cover shell and coincidently adapted for said jacks; said protected panels having apertures to be relatively communicated with said jacks; a ramp being provided by same side of said apertures relative to said same jack set; said protected panels could further slide between a first position where said apertures communicates abreast of said jacks and a second position where said apertures pass across with said jacks; each of said resumption assemblies including a resuming spring reversely arrange at an adverse orientation with respect to said ramps so as to render said jacks closed by aligning said ramps with said jacks.

2. The safety socket as claimed in claim 1, characterized in that said housing comprises a body cover shell, a top cover shell with jacks, a testing circuit of leakage signal disposed therein, an electromagnetic trip assembly controlled by said testing circuit, a contacting unit, a grounding unit, a power input connector, and a loading connector; both said power input connector and said loading connector have their respective wiring plates of conduction inserted into two inward sides of said body cover shell where a window is defined to exposed said wiring plates out thereof; said window has a groove for receiving and matching a secure shutter.

3. The safety socket as claimed in claim 1, characterized in that said safety socket has at least one set of said jacks in a T-shaped contour that formed by a horizontal and a vertical slots; said horizontal and vertical slots have their respective horizontal and vertical panels with resumption assemblies pivoted on the reverse side of said top cover shell and have their respective apertures disposed relative to said horizontal and vertical slots; said apertures with respect to said same jack set define ramps at the same relevant side thereof; said horizontal and vertical panels could further slide between a first position at which said apertures are abreast of said slots of said T-shaped jack and a second position where said apertures passes across said slots thereof; said resumption assemblies are set against said ramps, so that said ramps of said horizontal panel and said vertical panel could respectively and relatively align with said horizontal slot and said vertical slot of said T-shaped jack.

4. The safety socket as claimed in claim 2, characterized in that said safety socket has at least one set of said jacks in a T-shaped contour that formed by a horizontal and a vertical slots; said horizontal and vertical slots have their respective horizontal and vertical panels with resumption assemblies pivoted on the reverse side of said top cover shell and have their respective apertures disposed relative to said horizontal and vertical slots; said apertures with respect to said same jack set define ramps at the same relevant side thereof; said horizontal and vertical panels could further slide between a first position at which said apertures are abreast of said slots of said T-shaped jack and a second position where said apertures passes across said slots thereof; said resumption assemblies are set against said ramps, so that said ramps of said horizontal panel and said vertical panel could respectively and relatively align with said horizontal slot and said vertical slot of said T-shaped jack.
